(19) United States
(12) Patent Application Publication
(10) Pub. No.: US 2025/0038344 A1
(43) Pub. Date: Jan. 30, 2025

(54) PRESSURE COMPENSATION DEVICE FOR BATTERY HOUSING AND BATTERY HOUSING

(71) Applicant: MANN+HUMMEL GmbH, Ludwigsburg (DE)

(72) Inventors: Marco BATTEZZATI, Aidlingen (DE); Matthias HEIM, Steinach (DE); Stefan HASCHBERGER, Linsengericht (DE); Jürgen KOSICKI, Erligheim (DE)

(21) Appl. No.: 18/914,271

(22) Filed: Oct. 14, 2024

Related U.S. Application Data
(63) Continuation of application No. PCT/EP2023/058745, filed on Apr. 4, 2023.

(30) Foreign Application Priority Data
Apr. 13, 2022 (DE) 102022109065.5

(51) Int. Cl. H01M 50/342; H01M 50/30

(52) U.S. Cl. CPC H01M 50/342; H01M 50/394; H01M 2200/20

(57) ABSTRACT

A pressure compensation device for a battery housing includes a base body fluid-tightly connectable to an edge of a pressure compensation opening of the battery housing, and including a gas passage opening, a closure cap configured to, when a predetermined pressure difference between an interior space of the battery housing and an environment of the battery housing is exceeded, deflect in an axial direction from an initial position in a normal operating state of the pressure compensation device to transfer the pressure compensation device into an emergency degassing state, and a ramp fastening device configured to connect the closure cap and the base body, and including a ramp body disposed on the base body and extending in the axial direction, the ramp body including ramps on sides of the ramp body and facing away from one another in a radial direction.

### CROSS-REFERENCE TO RELATED APPLICATIONS

This application is a continuation application of International Application No. PCT/EP2023/058745 filed on Apr. 4, 2023, which claims the benefit of German Application No. 102022109065.5 filed on Apr. 13, 2022, the entire disclosures of which are incorporated herein by reference for all purposes.

### BACKGROUND

Embodiments relate to a pressure compensation device for a battery housing and the battery housing itself.

Battery housings are often provided with a pressure compensation device allowing pressure compensation between an interior space of the housing and the environment. If the housing were hermetically closed, pressure differences could be generated between the interior space and the environment during operation of the housing or of a device, such as an electrochemical energy storage device, disposed in the housing. By enabling pressure compensation through the pressure compensation device, the housing is prevented from mechanically failing during operation, for example by the housing bulging on the outside or ultimately even bursting or leaking.

For batteries or accumulators, in particular in the case of high-voltage batteries such as those used as traction batteries in electric vehicles, battery cell failure can occur, leading to a sharp increase in pressure and temperature in the interior space of the housing. In order to prevent the housing from bursting, the hot and extremely pressurized gas must be quickly discharged from the interior space of the housing to the environment.

DE 10 2012 022 346 B4 describes a degassing unit for a battery housing featuring a base body with a gas passage opening covered by a semi-permeable membrane permeable to gases but impermeable to liquids and solids, the membrane being connected to the base body in a stationary and fluid-tight manner. The base body can be connected in a fluid-tight manner to a pressure compensation opening of the battery housing. The semi-permeable properties of the membrane ensure gas exchange during normal operation, while an emergency degassing mandrel pointing towards the membrane is disposed on a cover body to realize an emergency degassing function perforating and rupturing the membrane when a limit expansion induced by an internal housing pressure is exceeded, so that abrupt pressure compensation from the interior space to the environment is possible. On an interior side facing the battery housing in an assembly condition, an inner protective grid is connected to the base body, which is intended to prevent foreign matter from entering the battery housing and which supports the membrane against water pressure from outside.

It is known that in the case of emergency degassing, cover bodies restrict the available degassing cross-section and are thus disadvantageous for the fastest possible pressure decrease.

This problem is addressed by DE 10 2020 109 148 A1, which describes a degassing unit that features a base body with a gas passage opening covered by a membrane. A cover body or protective cap is disposed on an exterior side of the base body to protect the membrane from harmful mechanical effects during normal operation. In case of emergency degassing, the protective cap can be separated from the base body so that it can be completely detached from the base body. The connection between the protective cap and the base body is realized using a positive engagement, in particular via corresponding snap hook elements. The protective cap is preferably made of plastic material.

The disadvantage here is that the switching point of the separation of the protective cap cannot be precisely determined in the case of mutual positive engagement due to manufacturing tolerances and/or inhomogeneous material properties. Furthermore, comparatively high differential pressures or forces are required to achieve separation of the protective cap. In addition, the use of plastic material in a positive contact poses aging problems, which means that the switching point for separating the protective cap cannot be kept constant over a planned service life, especially under the influence of thermal loads such as those occurring in the environment of a battery housing.

Based on this, the object is therefore to create a pressure compensation device featuring an improved emergency degassing behavior and, in particular, that can be triggered more accurately at lower differential pressures and reliably over a planned service life. Furthermore, the object is to create a battery housing having a pressure compensation device.

### SUMMARY

This object is solved by a pressure compensation device and by a battery housing.

Preferred embodiments and variants are specified in the respective subclaims and the description.

According to the embodiments, a pressure compensation device is provided for a battery housing, in particular for a battery housing of a traction battery, in particular for a motor vehicle. The pressure compensation device has a base body fluid-tightly connectable to an edge of a pressure compensation opening of the battery housing and which features at least one gas passage opening. The pressure compensation device further features a closure cap which, when a predetermined pressure difference between an interior space of the battery housing and an environment of the battery housing is exceeded, is deflectable in the axial direction from an initial position in a normal operating state of the pressure compensation device in order to transfer the pressure compensation device into an emergency degassing state.

According to the embodiments, the closure cap and the base body are connected by a ramp fastening device which features at least one ramp body extending in the axial direction and having at least one ramp. The ramp fastening device further comprises at least one pressure element which is pressed onto the ramp of the ramp body with a contact pressure. One of the apparatus components, ramp body or pressure element, is present on the base body and the other is present on the closure cap. In other words, according to the embodiments, either the ramp body is located on the closure cap and the pressure element is located on the base body or vice versa.

In advantageous embodiments, the ramp body can be present on the base body and the pressure element can be present on the closure cap.

The pressure element can slip off on the ramp when the closure cap is deflected under the action of the contact pressure.

Since the pressure element is pressed onto the ramp of the ramp body, mutual contact results in a frictional force that depends on the local ramp angle. The steeper the local ramp angle, the greater the axial force component counteracting the movement of the closure cap.

In contrast to the background art, the closure cap is not connected to the base body by positive locking, but rather by non-positive locking.

This has several advantages: On the one hand, a contour of the ramp can be dimensioned in such a way that the closure cap can already be axially displaced at very low differential pressures, which has a positive effect on the opening behavior of the pressure compensation device according to the embodiments in the case of emergency degassing. Since the closure cap can already be displaced at a lower differential pressure, the entire pressure compensation process can be significantly faster. On the other hand, the advantage is that the “switching point”, i.e., the predetermined differential pressure at which the closure cap is axially displaced, can be determined much more precisely using the ramp fastening device according to the embodiments than with known pressure compensation devices that rely on a positive fastening between base body and closure cap. Shape and dimensional tolerances as well as deviations in the material properties hardly play a role here-rather, the switching point to be expected with the device according to the embodiments depends almost exclusively on the local ramp angle, the contact pressure acting on the pressure element and the friction coefficients prevailing between the ramp and the pressure element.

As used herein, “axial direction” refers to a direction corresponding to the direction of a flow path leading from the interior space of the battery housing into the environment in an assembly condition. The term “radial direction” refers to the axial direction defined in such a way.

In embodiments, the ramp body extends in the axial direction, wherein the at least one ramp of the ramp body has a variable extension in the radial direction as viewed over the axial extension thereof.

According to a further embodiment, a ramp of the ramp body can rise in a direction of a flow path leading from the interior space of the battery housing into the environment in an assembly condition. In this way, on the one hand, a contact pressure acting between the closure cap and the base body can be generated in the normal operating state of the pressure compensation device and, on the other hand, a closing force counteracting the displacement of the closure cap in the direction of the flow path can be generated during the transfer to the emergency degassing state.

According to a further embodiment, the ramp body can be present within a cross-section of the gas passage opening. In particular, the ramp body can be connected to the base body via at least one fastening web extending from the edge of the gas passage opening. The at least one fastening web can extend in particular radially with respect to the gas passage opening. In embodiments, more than one fastening web can be provided, such as two, three, or even more. In embodiments, a continuous fastening web can be provided that extends across the gas passage opening and that supports or features, in particular centrally, the ramp body. In particular, the at least one fastening web can feature a flow-optimized cross-section, in particular in the form of a symmetrical flow profile.

The ramp body and the at least one fastening web can be designed in one piece with the base body, in particular injection-molded in one piece from a plastic material. This has the advantage that very cost-effective production is possible, since no assembly steps are necessary. Furthermore, an injection mold for producing the base body with integrated ramp body as well as the at least one fastening web is also comparatively cost-effective, since the ramp body features only insignificant undercuts that can be realized with a simple open-close mold. In the background art, which relies on a positive snap-fitting of plastic components for fastening the closure cap, such an injection molding tool is significantly more complex because several undercuts have to be realized.

In embodiments, the ramp body is disposed substantially coaxially with respect to the gas passage opening of the base body.

In embodiments, the ramp body can feature two ramps that are present on opposite sides of the ramp body. In particular, the two ramps can be present on sides of the ramp body facing away from each other in the radial direction. In particular, a pressure element is pressed onto both ramps with a contact pressure and can slip off on the ramps when the closure cap is deflected under the action of the contact pressure. The advantage is that comparatively high contact pressure and closing forces can be generated both during the normal operating state and during the transition to the emergency degassing state. Furthermore, this is associated with particularly good utilization of installation space, which avoids functional residual structures.

In embodiments, at least one ramp of the ramp body can feature a first ramp portion having a predetermined angle of slope between 3° and 85°, particularly between 45 and 75°.

The angle of slope is defined as the local angle of the ramp with respect to the axial direction.

According to a further embodiment, at least one ramp of the ramp body can feature a second ramp portion which adjoins the first ramp portion in the direction of the flow path leading out of the interior space of the battery housing into the environment in assembly condition. The second ramp portion can have a pitch angle that differs from the angle of slope of the first ramp portion.

By combining two or more ramp portions with different angles of slope, a variable force-deflection characteristic can be set over a predetermined axial range of deflection of the closure element. The local angles of slope of the ramp portions can also be adapted to a possibly non-linear, force-deflection characteristic of the pressure element.

In embodiments, the second ramp portion can have a smaller angle of slope than the first ramp portion. In particular, the angle of slope of the second ramp portion can be 0 to 60°, in particular 15 to 45°.

According to a still further embodiment, at least one of the ramps of the ramp body can feature a further ramp portion which adjoins the first or second ramp portion in the direction of the flow path leading out of the interior space of the battery housing into the environment in the assembly condition. The further ramp portion can slope downwards in the direction of the flow path leading out of the interior of the battery housing into the surroundings in the assembly condition.

As soon as the closure cap has been axially displaced in the opening direction to such an extent that the pressure element is located beyond a transition between the first or second ramp portion to the further ramp portion, a closing force is preferably no longer exerted on the closure cap, but rather an opening force is generated in the mutual contact between the pressure element and the further ramp portion and which supports the further movement of the closure cap in the direction of the flow path leading out of the interior space of the battery housing into the environment in the assembly condition. Advantageously, this enables the closure cap to be rapidly transferred to a state of its final deflection from a predetermined limit deflection, which further accelerates the emergency degassing process.

As long as the closure cap has been axially displaced in the opening direction only to the extent that the pressure element is located on this side of a transition between the first or second ramp portion and the further ramp portion, the opening movement of the closure cap is reversible, i.e., after the differential pressure effect has ceased, the closure cap returns to its initial position. However, if a magnitude of the differential pressure effect exceeds a predetermined limit value so that the closure cap is deflected in the opening direction to such an extent that the pressure element is located beyond the transition between the first or second ramp portion to the further ramp portion, the opening movement is not reversible.

In embodiments, at least one of the ramp portions of at least one of the ramps of the ramp body can have an angle of slope that is constant in itself or can have an angle of slope that varies in itself, in particular a progressive or degressive course. In this way, non-linear force-deflection characteristics can be realized at least sectionwise, which can be important in certain applications of the pressure compensation device in order to enable the best possible adaptation to systemic general conditions.

According to a further embodiment, the pressure element can comprise at least one spring element, in particular at least one spring leaf element. The spring element can in particular feature or consist of a metallic spring material.

Using a metallic material for the spring element of the pressure element has the advantage that the intended contact pressure of the spring element can be maintained virtually unchanged over a planned service life of the pressure compensation device. Metallic materials do not or hardly age at all and are insensitive to thermal stresses and certain radiation exposures. This is a clear technical advantage compared to the background art, which relies on a positive engagement using plastic snap hook, which—especially in the environment of a battery housing—are subject to significant aging phenomena. According to this, it is possible to ensure constant emergency degassing behavior over the entire planned service life of the pressure compensation device, which can be 10 to 15 years, by using a metallic spring element of the pressure element.

In embodiments, the spring element can be a spring bracket with at least two legs, wherein a pressing surface is formed on at least one of the legs, which is or can be brought into contact with the at least one ramp of the ramp body. The legs of the spring bracket can extend in particular with an axial component, in particular in the normal operating state with an axial component. The spring bracket can further feature a base connecting the two legs, so that the spring bracket has a U-shaped cross-section.

In embodiments, the spring bracket can in particular be connected to the closure element via the base, in particular to an interior face of the closure element. In particular, the connection of the spring bracket to the closure element can be non-detachable. In particular, the spring bracket can be connected to the closure element via a riveted, heated stamp or welded connection.

In the region of the at least one leg of the spring bracket in which the pressing surface is provided, the spring element can feature a bend pointing away from the ramp body, wherein a curved portion of the bend forms the pressing surface. The advantage is that the pressing surface has a rounded contour, thus facilitating sliding on a ramp of the ramp body and prevents damage to the ramp.

In embodiments, the portion of the leg of the spring bracket in which the bend is formed can include an angle with the axial direction between 0 and 80°, in particular between 1° and 40°. The corresponding portion of the leg of the spring bracket in which the bend is provided can in particular be bent radially inwards relative to the base. The advantage is that, even in the normal operating state, the pressing surface can be guided very simply and in a space-saving manner to the at least one ramp of the ramp body, so that a corresponding pretensioning of the spring bracket is provided.

According to a further example of an embodiment, it can be provided that the base body and/or the closure cap consist substantially of plastic material, in particular of a thermoplastic. In particular, both the base body and the closure cap are made of a plastic material, in particular a thermoplastic, in particular the same plastic material.

In embodiments, the base body can have a circumferential housing seal on its interior side, i.e., the side facing the battery housing in the assembly condition, which completely surrounds the gas passage opening. The housing seal can comprise a circumferential sealing groove in which a circumferential sealing element is inserted. In particular, the sealing groove can be axially oriented and/or the sealing element can be an axially effective sealing element. In other embodiments, however, the housing seal can also comprise a seal injection-molded onto the base body, in particular made of an elastomer or TPE, or at least a sealing lip formed from the material of the base body.

Furthermore, in embodiments, the ramp fastening device can comprise at least one stop device adjacent to the at least one ramp of the ramp body, which stop device can be brought into contact with the pressure element upon a predetermined axial deflection of the closure cap, so that an axial deflection of the closure cap is limited or can be limited.

Advantageously, the stop device enables the closure cap not to be completely separated or ejected from the base body during an emergency degassing process, but to be stopped in its final deflection and to remain secured to the base body and thus not to be lost.

In other embodiments, a catch element can be provided alternatively or additionally to alternatively connect the base body to the closure cap. A catch element can, for example, be a catch wire or a catch rope tensioned between the base body and the closure cap.

In embodiments, it can be provided that the gas passage opening is hermetically closed by the closure cap in the normal operating state. In its initial position, the closure cap can be sealingly pressed by an axial force against a circumferential sealing surface formed on an outer edge of the gas passage opening of the base body. The sealing surface can in particular be an axial or a combined axial-radial sealing surface.

In other embodiments, in the normal operating state, the closure cap can be spaced apart from the base body in its initial position, at least in some areas, to allow aeration/deaeration through the gas passage opening of the base body in the normal operating state.

In embodiments, it can be provided that the closure cap is pretensioned relative to the base body, in particular against the direction of the flow path leading out of the interior space of the battery housing into the environment in the assembly condition.

According to a further embodiment, the gas passage opening can be covered by a membrane, in particular a membrane allowing the passage of gaseous media, however preventing the passage of liquid and/or solid media.

Alternatively, in embodiments, the membrane can be a membrane that hermetically closes the gas passage opening, i.e., the membrane can also be a fluid-impermeable membrane.

In embodiments, the membrane can have a minimum width and/or a minimum length or a minimum external diameter equal to or greater than 20 mm. A thickness of the membrane can be at least 20 times, preferably at least 40 times, in particular at least 100 times, smaller than the minimum width and/or the minimum length or the minimum external diameter of the membrane. The membrane thickness can be from 1 micrometer to 5 millimeters, with a preferred membrane thickness of 0.1 to 2 mm, particularly 0.15 to 0.5 mm. The membrane can be suitable to meet a tightness requirement of at least 100 to 3000 mm water column (WS). The membrane can be made of plastic material, in particular of thermoplastic, for example polytetrafluoroethylene (PTFE).

In a further embodiment, the membrane can be present on an interior side of the base body with respect to intended assembly on the battery housing. The advantage is that the membrane can be held more securely on the base body in the case of an internal pressure load since the internal pressure load additionally presses the membrane onto the base body. In particular, the membrane can be connected to an edge of the gas passage opening surrounding the gas passage opening on an interior side of the base body. In particular, the membrane can be circumferentially glued or welded to the base body.

According to a still further embodiment, the membrane can be at least partially overlapped on the inside by at least one support grid, wherein the support grid in particular completely covers the cross-section of the gas passage opening. The support grid is provided to support the membrane in the event of a compressive load acting from the outside and to prevent inadmissible deformation or even destruction. In practical terms, an external compressive load can occur, for example, due to a relative air pressure increase or the action of a water column. In particular, the support grid can be made of a metallic material and can be connected, in particular non-detachably, to the base body. The support grid can feature a plurality of grid openings between which a plurality of grid webs extend. A dimension of the grid openings towards their smallest opening width can be 0.8 to 12.0 mm, in particular 1.0 to 3.0 mm. In addition to a support function due to external compressive load, the support grid also fulfills a certain particle separation function because of emergency degassing, since particles produced in the case of a defect in at least one battery cell disposed in the battery housing can be retained. In embodiments, several grids can also be present on the interior side of the base body, for example a support grid close to the membrane and a separating grid further away from the membrane, through which particles flow serially because of emergency degassing. The separating grid can act as a particle pre-separator and feature larger grid openings.

Finally, according to a further embodiment, the pressure compensation device can have an emergency degassing mandrel which extends on an exterior side of the membrane against the direction of the flow path leading from the interior space of the battery housing to the environment in the assembly condition. In particular, the emergency degassing mandrel can be present on the base body, in particular formed on a ramp body disposed on the base body.

A tip of the emergency degassing mandrel can be present at a predetermined distance from an outer membrane surface in the normal operating state. The emergency degassing mandrel is located at a predetermined distance from the membrane surface when at rest (no differential compressive load). Under compressive load (relative internal overpressure), the membrane will bulge towards the external space and come into contact with the tip of the emergency degassing mandrel when a limit pressure is reached. Due to its tip, the emergency degassing mandrel then produces a targeted weakening of the membrane causing it to rupture. This serves to ensure that the emergency degassing function is as nimble as possible, which is important in order to be able to ensure that the housing structure remains intact if a sudden increase in internal pressure occurs in the battery housing. By varying the distance of the tip of the emergency degassing mandrel from the membrane surface, the emergency degassing pressure can be adjusted.

A battery housing according to the embodiments is in particular a battery housing of a traction battery, in particular of a motor vehicle. The battery housing features a pressure compensation opening, wherein a pressure compensation device is connected to an edge of the pressure compensation opening. The pressure compensation device is a pressure compensation device according to the embodiments.

All features, combinations of features as well as their specific technical advantages disclosed in the context of the pressure compensation device according to the embodiments are transferable to the battery housing according to the embodiments and vice versa.

### BRIEF DESCRIPTION OF DRAWINGS

FIG. 1 is a top view of a pressure compensation device according to a first embodiment.

FIG. 2 is section A-A according to FIG. 1, pressure compensation device in normal operating state.

FIG. 3 is section A-A according to FIG. 1, pressure compensation device in emergency degassing state.

FIG. 4 is section B-B according to FIG. 1, pressure compensation device in normal operating state.

FIG. 5 is section B-B according to FIG. 1, pressure compensation device in emergency degassing state.

FIG. 6 is an isometric view of the pressure compensation device according to the first embodiment.

FIG. 7 is section A-A according to FIG. 1 of a pressure compensation device according to a second embodiment.

FIG. 8 is an isometric view of the pressure compensation device according to the second embodiment.

FIG. 9 is a top view of a pressure compensation device according to a third embodiment.

FIG. 10 is section A-A according to FIG. 9, pressure compensation device in normal operating state.

FIG. 11 is section A-A according to FIG. 9, pressure compensation device in emergency degassing state.

FIG. 12 is section B-B according to FIG. 9, pressure compensation device in normal operating state.

FIG. 13 is section B-B according to FIG. 9, pressure compensation device in emergency degassing state.

FIG. 14 is an isometric view of the pressure compensation device according to the third embodiment.

### DETAILED DESCRIPTION

Identical or similar components in the figures have the same reference numerals. The figures only show examples and are not to be understood in a restrictive way. Features or combinations of features disclosed in connection with a particular embodiment are—if not explicitly excluded—also applicable to the other embodiments.

All figures show the pressure compensation device 10 according to the embodiments in an installed state with a portion of a wall of a battery housing 100.

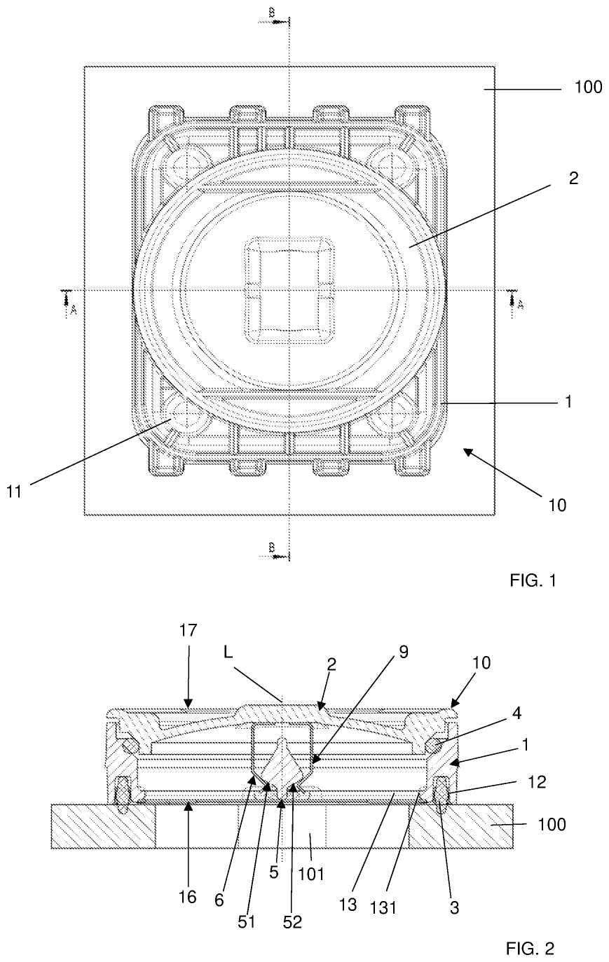

FIG. 1 shows a first embodiment of the pressure compensation device 10 in a top view, while FIG. 2 shows the section A-A in the normal operating state. The pressure compensation device 10 features a base body 1 fastened or fastenable to a wall of a battery housing 100 using fastening elements 11, for example screws. The base body 1 features a gas passage opening 13 covered on an exterior side 17 by a closure cap 2. A pressure compensation opening 101 is provided in the battery housing 100, wherein the pressure compensation device 10 is fluid-tightly connected to the wall of the battery housing 100 in a peripheral area of the pressure compensation opening 101. An overpressure arising due to a defect in a battery cell disposed in the battery housing 100 can escape through the pressure compensation opening 101 of the battery housing 100 and is directed to the gas passage opening 13 of the base body 1.

The base body 1 is circumferentially fluid-tightly sealed around the edge of the pressure compensation opening 101 with respect to the battery housing 100.

For this purpose, the base body 1 has on its interior side 16 a housing seal groove 12 surrounding the gas passage opening 13, in which a housing seal is disposed. The gas passage opening 13 is formed as a fluid-permeable cross-section in an interior space of the base body 1 enclosed by the edge 131 of the gas passage opening 13. The housing seal 3 has a bulbous cross-section, securely retaining it in the housing seal groove 12 even in the unassembled state. The housing seal 3 is an axial seal developing its sealing effect by relative axial compression of the base body 1 with respect to the battery housing 100, wherein the necessary pretensioning force is generated by the fastening elements 11.

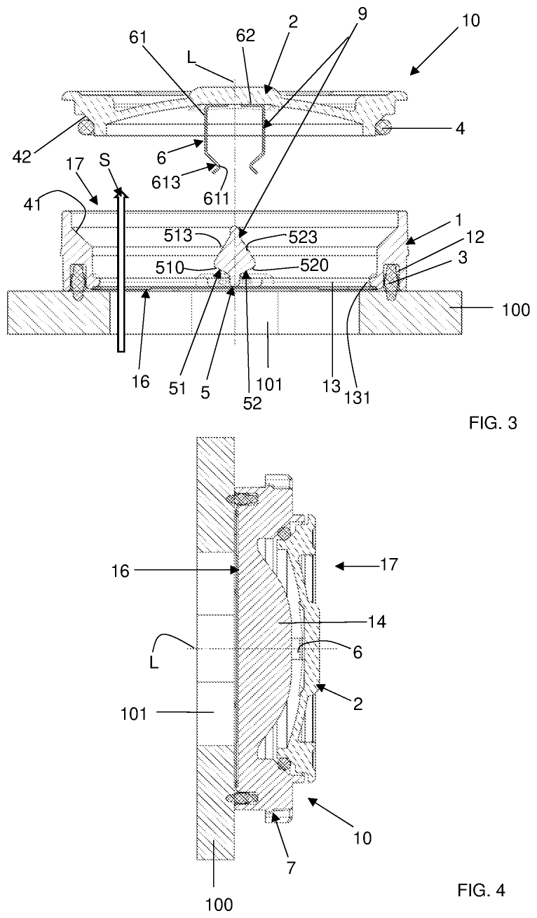

The closure cap 2 hermetically closes the gas passage opening 13 in the normal operating state of the pressure compensation device 10, so that no gas exchange can take place from the battery housing 100 to the environment or vice versa. In the first embodiment, the closure cap 2 therefore assumes the function of a valve body. The sealing effect in the normal operating state is realized by a closure cap seal 4 pressed between circumferential sealing surfaces 41, 42 (see FIG. 3) of the base body 1 and the closure cap 2. The circumferential sealing surfaces 41, 42 have a conical shape, thus improving the sealing effect. In embodiments, the closure cap seal 4 can be a combined radially-axially effective seal. The closure cap seal 4 comprises a sealing element, which is designed in particular as an O-ring. In other embodiments not shown in the figure, the closure cap seal 4 can feature a sealing element (2K sealing element) injection-molded onto the closure cap 2 or the base body 1.

The pretensioning force required to compress the closure cap seal 4 is generated by a ramp fastening device 9 connecting the closure cap 2 to the base body 1.

The ramp fastening device 9 comprises a ramp body 5 fixed to the base body 1 and a pressure element 6 fixed to the closure cap. The ramp body 5 comprises two ramps 51, 52 provided on opposite sides of the ramp body 5. The pressure element 6 is designed as a spring bracket and exerts a contact pressure on the respective ramps 51, 52 of the ramp body 5 in the area of two pressing surfaces 611 (see FIG. 3).

Since the ramps 51, 52 in the area of a contact position of the pressing surfaces 611 of the pressure element 6 rise in a direction pointing from the inside 16 to the outside 17 in the normal operating state, a closing force acting in the axial direction L is generated by the mutual contact of the pressure element 6 and the ramp body 5, which presses the closure cap 2 onto the base body 1.

The ramp body 5 extends within a cross-section of the gas passage opening 13, in particular centrally in the cross-section of the gas passage opening 13.

In case of a malfunction of a battery cell disposed in the battery housing 100, an internal housing pressure is generated which acts on an interior side of the closure cap 2 and exerts an opening force directed in the axial direction L on the closure cap 2. If the opening force exceeds a predetermined limit value that exceeds the contact pressure in the normal operating state, the closure cap 2 is lifted off the base body 1 in the axial direction L, i.e., axially displaced relative to the base body 1.

In this connection, the spring bracket 6 is radially widened and the pressing surfaces 611 slide on the ramps 51, 52 of the ramp body 5. The opening force required to transfer the pressure compensation device 10 can be precisely determined by dimensioning the friction conditions prevailing in the contact between the ramp body 5 and the pressure element 6 and by adjusting the ramp angle accordingly.

FIG. 3 shows the pressure compensation device in its emergency degassing state, in which the closure cap 2 has been axially displaced and is separated from the base body 1. Due to the complete separation, a maximum passage cross-section can be provided for a flow path S during emergency degassing, which is advantageous for ensuring rapid pressure decrease in the battery housing.

In FIG. 3, the structure of the ramp body 5 and the pressure element 6 can be clearly seen. The ramps 51, 52 of the ramp body 5 comprise a first ramp portion 510, 520 in which the pressing surfaces 611 of the pressure element 6 rest in the normal operating state. The ramp portions 510, 520 feature a first angle of slope which is 30 to 85°, in particular 45 to 75°. The gradient in the first ramp portion 510, 520 significantly influences the contact pressure in the normal operating state and determines the opening force required to switch the pressure compensation device 10 to the emergency degassing state, so that the opening pressure of the pressure compensation device 10 is determined by this. Following the first ramp portion 510, 520 in the direction of the flow path S during emergency degassing, the ramps 51, 52 each feature a further ramp portion 513, 523 which slopes in the direction of the flow path S during emergency degassing, i.e., from the inside 16 to the outside 17. Between the first ramp portion 510, 520 and the further ramp portion 513, 523 is a transition area which can extend in the axial direction L.

As soon as the closure cap has been displaced axially to such an extent that the pressing surfaces 611 of the pressure element 6 are beyond the transition area, the opening movement of the closure cap 2 is irreversible, separating it from the base body 1.

The pressure element 6 is attached to an interior side of the closure cap 2, for example screwed, riveted or connected to the closure cap 2 by a heating plunger connection. The pressure element 6 is designed as a spring bracket featuring two legs 61 extending with an axial component towards the base body 1. The legs 61 are connected by a base 62, via which the pressure element 6 is connected to the closure cap 2. The pressure element 6 is preferably made of a metallic material, such as a spring steel. The legs 61 of the pressure element 6 each feature a bend 613 which comprises a radially outwardly bent portion which in each case forms a pressing surface 611 which can be brought into contact with the ramps 51, 52 of the ramp body. The pressing surfaces 611 thus feature a rounded contour and can therefore slide on the ramps 51, 52 without causing surface damage.

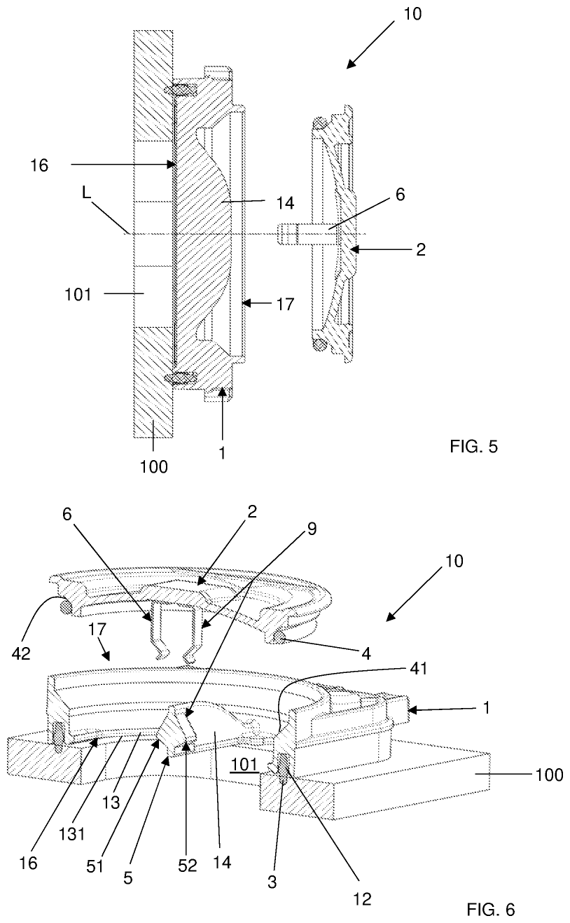

FIG. 4 and FIG. 5 show the pressure compensation device 10 according to the first embodiment in section B-B of FIG. 1. In this connection in particular, the fastening of the ramp body 5 to the base body can be clearly seen. The ramp body 5 is connected to the base body 1 via a fastening web 14, which covers the gas passage opening 13. The fastening web 14 extends in radial direction, but in embodiments it can also extend tangentially. The fastening web 14 is injection-molded together with the ramp body 5 and the base body 1 in one piece, in particular in one piece from thermoplastic.

Finally, FIG. 6 shows an isometric sectional view according to section A-A of FIG. 1 of the first embodiment of the pressure compensation device 10. The interaction of the apparatus components can be clearly seen here. In particular, the flow-optimized cross-section of the fastening web 14 can be seen, which is rounded on the upstream (inside) and downstream (outside) sides in order to influence the flow S as little as possible in the case of emergency degassing.

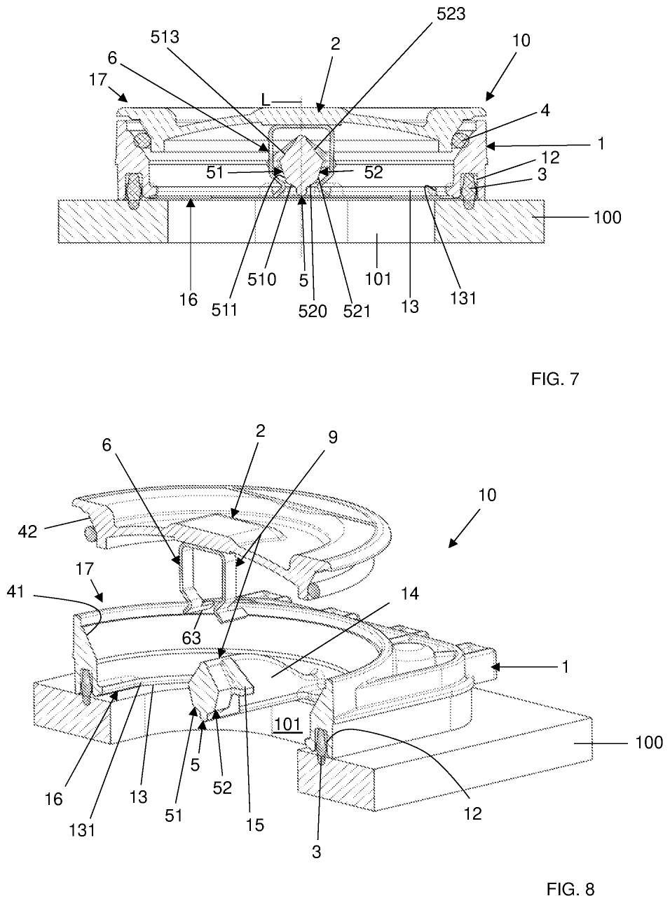

The second embodiment of the pressure compensation device 10 shown in FIG. 7 and FIG. 8 is substantially the same as the first embodiment, so that all the features described with reference to the first embodiment, as well as their specific combinations and advantages, are transferable to the second embodiment. Therefore, only the differences with respect to the first embodiment will be discussed.

The ramp body 5 comprises two ramps 51, 52 designed on sides of the ramp body 5 facing away from each other. The ramps 51, 52 each comprise a first ramp portion 510, 520 in which the pressing surfaces 611 of the pressure element 6 rest in the normal operating state. The ramp portions 510, 520 feature a first angle of slope which is 30 to 85°, in particular 45 to 75°. The gradient in the first ramp portion 510, 520 has a significant influence on the contact pressure in the normal operating state and determines the opening force required to transfer the pressure compensation device 10 to the emergency degassing state, so that the opening pressure of the pressure compensation device 10 is determined by this. Following the first ramp portion 510, 520 in the direction of the flow path S during emergency degassing, the ramps 51, 52 each feature a second ramp portion 511, 521 whose angle of slope is smaller than the angle of slope of the first ramp portion 510, 520. This has the advantage that the closure cap 2 can be displaced axially back again after displacement in the axial direction in the emergency degassing state of the pressure compensation device 10, allowing the closure cap 2 to return to its initial position.

Following the second ramp portion 511, 521 in the direction of the flow path S during emergency degassing, the ramps 51, 52 each have a further ramp portion 513, 523 which slopes in the direction of the flow path S during emergency degassing, i.e., from inside 16 to outside 17.

As soon as the closure cap has been displaced axially to such an extent that the pressing surfaces 611 of the pressure element 6 are beyond a transition between the second ramp portion 511, 521 and the further ramp portion 513, 523, the opening movement of the closure cap 2 is irreversible.

Furthermore, the pressure compensation device 10 according to the second embodiment features a stop device 15 provided to prevent the closure cap 2 from being completely separated from the base body 1 after an emergency degassing process. The stop device 15 provides an axial stop against which the pressure element 6 comes to rest when an end deflection is reached. The stop device 15 is designed adjacent to the ramp body 5 on the base body 1 and features a stop surface oriented axially inwards 16, which has a greater radial extent than the ramps 51, 52. The stop device 15 can in particular be made in one piece together with the ramp body 5, the fastening web 14 and the base body 1, in particular injection molded in one piece from thermoplastic.

The pressure element 6 features a corresponding stop portion 63 designed to come into contact with the stop surface of the stop device 15 in the end deflection. The stop portion 63 of the pressure element 6 is designed as a portion of the spring bracket extending transversely to the longitudinal extension of the legs 61 of the spring bracket. The stop portion 63 is designed in particular in an end portion of the legs 61 of the spring bracket. The stop portion 63 can in particular have a greater transverse extent than the legs 61 of the spring bracket.

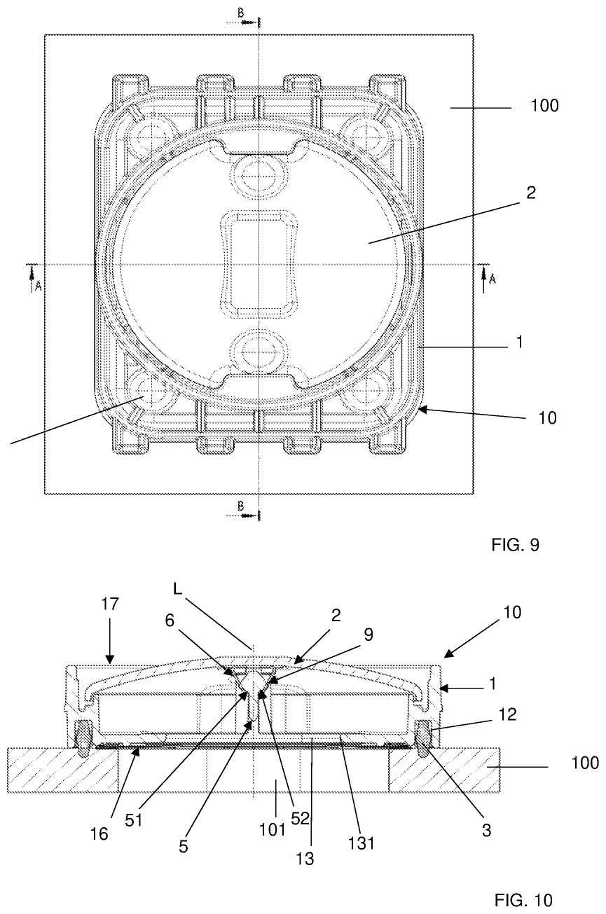

FIG. 9 shows a third embodiment of the pressure compensation device 10 in a top view, while FIG. 10 shows the section A-A in the normal operating state. The pressure compensation device 10 features a base body 1 which is attached or attachable to a wall of a battery housing 100 via fastening elements 11, for example screws. The base body 1 features a gas passage opening 13 covered on an exterior side 17 by a closure cap 2. A pressure compensation opening 101 is provided in the battery housing 100, wherein the pressure compensation device 10 is connected to the wall of the battery housing 100 in a peripheral area of the pressure compensation opening 101. An overpressure arising due to a defect in a battery cell disposed in the battery housing 100 can escape through the pressure compensation opening 101 of the battery housing 100 and is directed to the gas passage opening 13 of the base body 1.

The base body 1 is circumferentially fluid-tightly sealed around the edge of the pressure compensation opening 101 with respect to the battery housing 100.

For this purpose, the base body 1 has on its interior side 16 a housing seal groove 12 surrounding the gas passage opening 13, in which a housing seal is disposed. The gas passage opening 13 is formed as a fluid-permeable cross-section in an inner space enclosed by the edge 131 of the gas passage opening 13. The housing seal 3 has a bulbous cross-section, securely retaining it in the housing seal groove 12 even in the unassembled state. The housing seal 3 is an axial seal developing its sealing effect by relative axial compression of the base body 1 with respect to the battery housing 100.

In the normal operating state of the pressure compensation device 10, the closure cap 2 covers the gas passage opening 13, wherein a gas passage cross-section is formed between the base body 1 and the closure cap 2 so that pressure compensation can take place between the battery housing and the environment and vice versa in the normal operating state. The gas passage cross-section is formed in particular between an outwardly 17 pointing circumferential edge of the gas passage opening of the base body 1 and an interior side of the closure cap 2. The function of the closure cap 2 is primarily to protect a membrane 8 (see FIG. 14) covering the gas passage opening 13 from external damage in the normal operating state.

The closure cap 2 is connected to the base body 1 via a ramp fastening device 9.

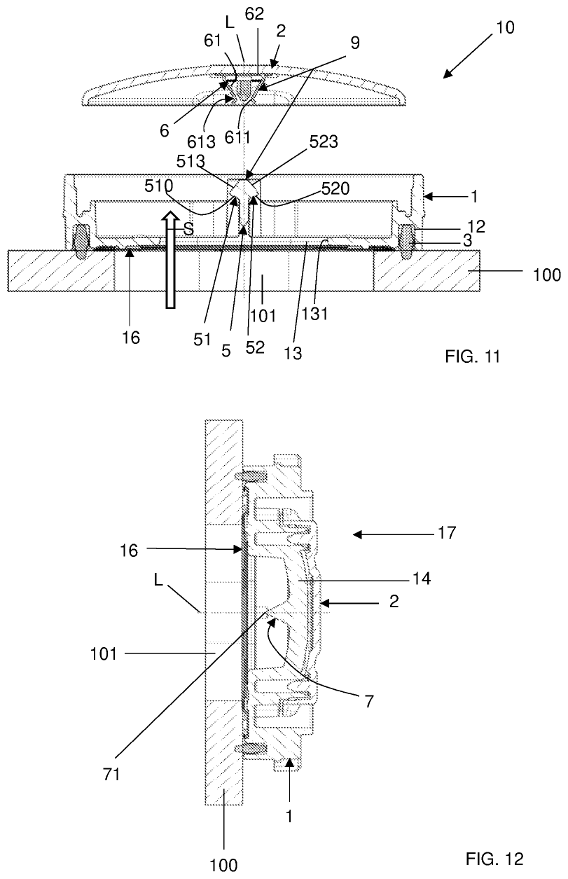

The ramp fastening device 9 comprises a ramp body 5 fixed to the base body 1 and a pressure element 6 fixed to the closure cap. The ramp body 5 comprises two ramps 51, 52 provided on opposite sides of the ramp body 5. The pressure element 6 is designed as a spring bracket and exerts a contact pressure on the respective ramps 51, 52 of the ramp body 5 in the area of two pressing surfaces 611 (see FIG. 11).

Since the ramps 51, 52 in the area of a contact position of the pressing surfaces 611 of the pressure element 6 rise in a direction pointing from the inside 16 to the outside 17 in the normal operating state, a closing force acting in the axial direction L is generated by the mutual contact of the pressure element 6 and the ramp body 5, which presses the closure cap 2 onto the base body 1 in the normal operating state.

The ramp body 5 extends within a cross-section of the gas passage opening 13, in particular centrally in the cross-section of the gas passage opening 13.

In case of a malfunction of a battery cell disposed in the battery housing 100, an internal housing pressure is generated which acts on an interior side of the closure cap 2 and exerts an opening force directed in the axial direction L on the closure cap 2. If the opening force exceeds a predetermined limit value that exceeds the contact pressure in the normal operating state, the closure cap 2 is lifted off the base body 1 in the axial direction L, i.e., axially displaced relative to the base body 1.

In this connection, the spring bracket 6 is radially widened and the pressing surfaces 611 slide on the ramps 51, 52 of the ramp body 5. The opening force required to transfer the pressure compensation device 10 can be precisely determined by dimensioning the friction conditions prevailing in the contact between the ramp body 5 and the pressure element 6 and by adjusting the ramp angle accordingly.

FIG. 11 shows the pressure compensation device in its emergency degassing state, in which the closure cap 2 has been axially displaced and is separated from the base body 1. Due to the complete separation, a maximum passage cross-section can be provided for a flow path S during emergency degassing, which is advantageous for ensuring rapid pressure decrease in the battery housing.

In FIG. 11, the structure of the ramp body 5 and the pressure element 6 can be clearly seen. The ramps 51, 52 of the ramp body 5 comprise a first ramp portion 510, 520 in which the pressing surfaces 611 of the pressure element 6 rest in the normal operating state. The ramp portions 510, 520 feature a first angle of slope which is 30 to 85°, in particular 45 to 75°. The gradient in the first ramp portion 510, 520 significantly influences the contact pressure in the normal operating state and determines the opening force required to switch the pressure compensation device 10 to the emergency degassing state, so that the opening pressure of the pressure compensation device 10 is determined by this. Following the first ramp portion 510, 520 in the direction of the flow path S during emergency degassing, the ramps 51, 52 each feature a further ramp portion 513, 523 which slopes in the direction of the flow path S during emergency degassing, i.e., from the inside 16 to the outside 17. Between the first ramp portion 510, 520 and the further ramp portion 513, 523 is a transition area.

As soon as the closure cap has been displaced axially to such an extent that the pressing surfaces 611 of the pressure element 6 are beyond the transition area, the opening movement of the closure cap 2 is irreversible, separating it from the base body 1.

The pressure element 6 is attached to an interior side of the closure cap 2, for example screwed, riveted or connected to the closure cap 2 by a heating plunger connection. The pressure element 6 is designed as a spring bracket featuring two legs 61 extending with an axial component towards the base body 1. The legs 61 are connected by a base 62, via which the pressure element 6 is connected to the closure cap 2. The pressure element 6 is preferably made of a metallic material, such as a spring steel. The legs 61 of the pressure element 6 each feature a bend 613 which comprises a radially outwardly bent portion which in each case forms a pressing surface 611 which can be brought into contact with the ramps 51, 52 of the ramp body. The pressing surfaces 611 thus feature a rounded contour and can therefore slide on the ramps 51, 52 without causing surface damage.

The portion of the leg 61 of the spring bracket in which the bend 613 is formed encloses an angle of between 0 and 80°, in particular between 1° and 40°, together with the axial direction L. The corresponding portion of the leg 61 of the spring bracket, in which the bend 613 is provided, is bent radially inwards relative to the base 62. The advantage is that, in the normal operating state, the pressing surface 611 can be guided very simply and in a space-saving manner to the at least one ramp 51, 52 of the ramp body 5, so that a corresponding pretensioning of the spring bracket is provided.

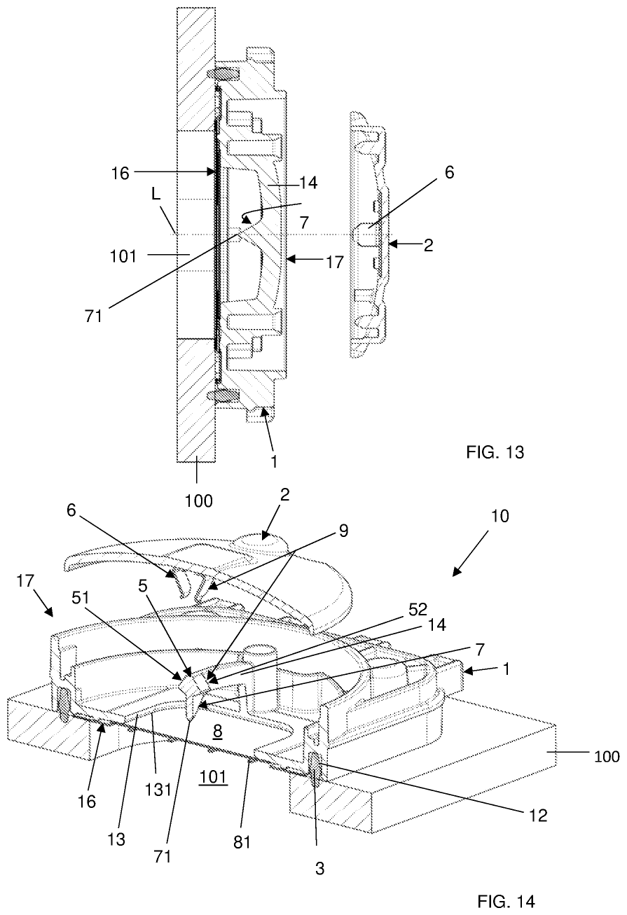

FIG. 12 and FIG. 13 show the pressure compensation device 10 according to the third embodiment in section B-B of FIG. 9. In this connection in particular, the fastening of the ramp body 5 to the base body can be clearly seen. The ramp body 5 is connected to the base body via a fastening web 14 which covers the gas passage opening 13. The fastening web 14 extends in radial direction, but in embodiments it can also extend tangentially. The fastening web 14 is injection-molded together with the ramp body 5 and the base body 1 in one piece, in particular in one piece from thermoplastic.

Finally, FIG. 14 shows an isometric sectional view according to section A-A of FIG. 9 of the third embodiment of the pressure compensation device 10. The interaction of the apparatus components can be clearly seen here. In particular, the flow-optimized cross-section of the fastening web 14 can be seen, which is rounded on the upstream (inside) and downstream (outside) sides in order to influence the flow S as little as possible in the case of emergency degassing.

Furthermore, the pressure compensation device 10 features a membrane 8 that covers the gas passage opening 13. The membrane 8 is disposed on an interior side of the base body 1 and connected, for example glued or welded to the base body 1 in the area of the edge 131 of the gas passage opening 13. In particular, the membrane 8 can be a semi-permeable membrane that permits the passage of gaseous substances but prevents the passage of liquid or solid substances. The membrane 8 allows the pressure compensation device 10 to allow pressure compensation between the battery housing and the environment and vice versa in the normal operating state. This is important when implementing the pressure compensation device 10 to avoid detrimental effects on the structure of a battery housing due to relative air pressure changes and/or water columns. The membrane 8 is further engaged from behind by a support grid 81 that covers the interior side of the membrane 8. The support grid 81 is fluid-permeable and has a plurality of grid openings between which a plurality of grid webs extend. The support grid 81 is provided to support the membrane 8 in the event of a compressive load acting from the outside and to prevent inadmissible deformation or even destruction. The support grid 81 can be formed in one piece with the base body 1 or as a separate component. In particular, the support grid 81 features a metallic material or consists thereof. In particular, the support grid 81 can be non-detachably connected to the base body 1, for example using a heating plunger connection.

Finally, the pressure compensation device 10 features an emergency degassing mandrel 7. It extends towards the membrane 8 and is disposed at a predetermined distance from the outer membrane surface when at rest (no differential compressive load). Under compressive load (relative internal overpressure), the membrane 8 will bulge towards the outside and come into contact with the tip 71 of the emergency degassing mandrel 7 when a limit pressure is reached. Due to its tip 71, the emergency degassing mandrel 7 then produces a targeted weakening of the membrane 8 causing it to rupture. This serves to ensure that the emergency degassing function is as nimble as possible, which is important in order to be able to ensure that the housing structure remains intact if a sudden increase in internal pressure occurs in the battery housing. By varying the distance of the tip 71 of the emergency degassing mandrel 7 from the surface of the membrane 8, the emergency degassing pressure can be adjusted.

After the rupture of the membrane 8, a relative overpressure enters an interior space of the base body 1 covered to the outside by the closure cap 2, so that the overpressure can act on the closure cap 2 and the closure cap 2 is separated from the base body 1 as described above.

The emergency degassing mandrel 7 is formed in one piece with the ramp body 5. In particular, the emergency degassing mandrel 7 is injection molded in one piece with the ramp body 5, the fastening web 14 and the base body 1, in particular in one piece from thermoplastic.

1. A pressure compensation device for a battery housing, the pressure compensation device comprising:
a base body fluid-tightly connectable to an edge of a pressure compensation opening of the battery housing, and comprising a gas passage opening;
a closure cap configured to, when a predetermined pressure difference between an interior space of the battery housing and an environment of the battery housing is exceeded, deflect in an axial direction from an initial position in a normal operating state of the pressure compensation device to transfer the pressure compensation device into an emergency degassing state; and
a ramp fastening device configured to connect the closure cap and the base body, and comprising:
a ramp body disposed on the base body and extending in the axial direction, the ramp body comprising ramps on sides of the ramp body and facing away from one another in a radial direction, the ramps comprising first ramp portions and further ramp portions adjoining the first ramp portions in a direction of a flow path from the interior space of the battery housing to the environment, and each of the further ramp portions having a positive slope differing from a negative slope of a respective one of the first ramp portions; and
a pressure element disposed on the closure cap and comprising a spring bracket that comprises a metallic spring material, the spring bracket comprising legs, each of which comprising a pressing surface configured to:
press onto a respective one of the first ramp portions with a contact pressure, in the initial position of the closure cap; and
slip off a respective one of the ramps when the closure cap is deflected.

2. The pressure compensation device according to claim 1, wherein the ramp body is present within a cross-section of the gas passage opening, and
wherein the ramp body is connected to the base body via at least one fastening web extending from at least one edge of the gas passage opening.

3. The pressure compensation device according to claim 1, wherein each of the first ramp portions has a predetermined angle of inclination between 30° and 85°.

4. The pressure compensation device according to claim 1, wherein ramps further comprise second ramp portions interposed between the first ramp portions and the further ramp portions in the direction of the flow path from the interior space of the battery housing to the environment, each of the second ramp portions having an angle of slope differing from an angle of slope of a respective one of the first ramp portions and an angle of slope of a respective one of the further ramp portions.

5. The pressure compensation device according to claim 4, wherein the angle of slope of each of the second ramp portions is less than the angle of slope of the respective one of the first ramp portions, the angle of slope of each of the second ramp portions being 0° to 60°.

6. The pressure compensation device according to claim 1, wherein the ramp fastening device further comprises a stop device adjacent to the ramps and having a greater radial extent than the ramps, the stop device being configured to contact the pressure element when the closure cap is deflected, so that an axial deflection of the closure cap is limited.

7. The pressure compensation device according to claim 1, wherein the gas passage opening is hermetically closed by the closure cap in the normal operating state, and
wherein the closure cap is sealingly pressed by an axial force against a circumferential sealing surface disposed on an outer edge of the gas passage opening in the initial position.

8. The pressure compensation device according to claim 1, wherein, in the normal operating state, the closure cap is spaced apart from the base body in the initial position, at least in some areas, to allow aeration/deaeration through the gas passage opening.

9. The pressure compensation device according to claim 1, wherein the closure cap is pretensioned relative to the base body, against the direction of the flow path from the interior space of the battery housing to the environment.

10. The pressure compensation device according to claim 1, wherein the pressure compensation device further comprises a membrane covering the gas passage opening and configured to allow a passage of gaseous media and prevent a passage of liquid and/or solid media.

11. The pressure compensation device according to claim 10, wherein the membrane is disposed on an interior side of the base body with respect to an intended assembly on the battery housing, the membrane being connected to an edge of the gas passage opening.

12. The pressure compensation device according to claim 10, wherein the membrane is at least partially overlapped by a support grid, the support grid completely covering a cross-section of the gas passage opening.

13. The pressure compensation device according to claim 10, wherein the pressure compensation device further comprises an emergency degassing mandrel disposed on the ramp body and extending from the ramp body against the direction of the flow path from the interior space of the battery housing to the environment, to the membrane.

14. A battery housing comprising:
a pressure compensation opening; and
the pressure compensation device according to claim 1 and being connected to an edge of the pressure compensation opening.
